(19) United States
(12) Patent Application Publication
(10) Pub. No.: US 2002/0038824 A1
(43) Pub. Date: Apr. 4, 2002

(54) Electrostatic spray gun

(76) Inventor: Mark E. Ulrich, Brooklyn Park, MN (US)

Correspondence Address: Douglas B. Farrow, Corporate Intellectual Property Counsel, Graco Inc., P.O. Box 1441, Minneapolis, MN, 55440-1441, US

(21) Appl. No.: 09/961,097

(22) Filed: Sep. 21, 2001

Related U.S. Application Data
(60) Provisional application No. 60/237,026, filed on Sep. 29, 2000.

(51) Int. Cl. B05B 7/02

(52) U.S. Cl. 239/526

(57) ABSTRACT

Placement of the alternator/turbine assembly (20, 22) in the handle (12) allows lowering of the center of gravity of the spray gun along with allowing it to be made much more compact.

### TECHNICAL FIELD

This application is a continuation-in-part of U.S. application Ser. No. 60/237,026, filed Sep. 29, 2000.

### BACKGROUND ART

Previous turbine powered electrostatic spray guns have located both the alternator turbine assembly and the multiplier in the gun barrel or upper portion of the gun handle behind the barrel.

### DISCLOSURE OF THE INVENTION

Placement of the alternator assembly in the handle allows lowering of the center of gravity of the spray gun along with allowing it to be made much more compact.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a cross-section of the device of the instant invention.

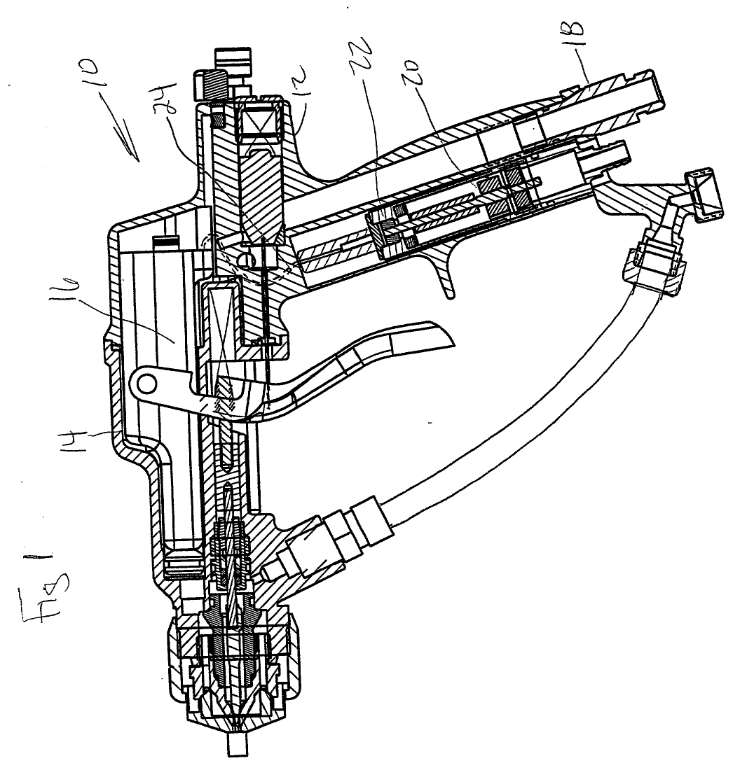

### BEST MODE FOR CARRYING OUT THE INVENTION

The spray gun generally designated 10 has a handle 12 which is connected to a barrel 14. Located in barrel 14 and a portion of handle 12 is multiplier 16. Handle 12 has an air inlet 18 which leads to turbine 20 which rotates at relatively high speed and rotates alternator 22 which is in turn connected via connector 24 to multiplier 16.

It is contemplated that various changes and modifications may be made to the electrostatic spray gun without departing from the spirit and scope of the invention as defined by the following claims.

1. In an electrostatic spray gun having a hand-engaging portion and a barrel portion, a barrel, a multiplier and an alternator-turbine set, the improvement comprising locating said alternator-turbine set in said hand engaging portion so as to enable the construction of a compact electrostatic spray gun.
